(19) United States
(12) Patent Application Publication
(10) Pub. No.: US 2014/0032520 A1
(43) Pub. Date: Jan. 30, 2014

(54) Image retrieval method and system for community website page

(71) Applicant: TENCENT TECHNOLOGIES (SHENZHEN) COMPANY LIMITED, Shenzhen (CN)

(72) Inventor: Ziming Zhuang, Shenzhen (CN)

(21) Appl. No.: 14/040,612

(22) Filed: Sep. 27, 2013

Related U.S. Application Data
(63) Continuation of application No. PCT/CN2012/080294, filed on Aug. 17, 2012.

(30) Foreign Application Priority Data
Sep. 8, 2011 (CN) 2011102653850

(51) Int. Cl. G06F 17/30

(52) U.S. Cl. CPC G06F 17/30864; G06F 17/30268
USPC 707/706

(57) ABSTRACT

The disclosure discloses an image retrieval method and system for a community website page. The method comprises: acquiring keywords of image retrieval from the community website page and retrieving images in a corresponding search engine according to the acquired keywords; and displaying the retrieved images via the community website page. Through the disclosure, the complexity of image acquisition can be reduced for the user in the page entering process, thereby improving the entering efficiency and enhancing the user experience.

### CROSS REFERENCE TO RELATED APPLICATIONS

This is a continuation application of International Patent Application No.: PCT/CN2012/080294, filed on Aug. 17, 2012, which claims priority to Chinese Patent Application No.: 2011102653850 filed on Sep. 08, 2011, the disclosure of which is incorporated by reference herein in its entirety.

### TECHNICAL FIELD

The disclosure relates to the field of Internet technology, in particular to an image retrieval method and system for a community website page.

### BACKGROUND

With the continuous development of the Internet technology, various Internet application products are increasingly diverse. Most of the currently popular community websites provide users with functions of image uploading and image linking, some of them even provide a series of preset images for users to choose. Take example for micro blog community, which is one kind of community network, the micro blog community as shown in FIG. 1 provides users with functions of image uploading and image linking, while the micro blog community as shown in FIG. 2 provides a series of preset images for users to choose, in addition to providing the functions of image uploading and image linking.

However, in the prior art, when a user enters a text and/or an image on an Internet page, when there is no image, that the user wants to upload, in his client and the preset images provided by the Internet do not meet the user requirements, the user would have to access a search engine or an image resource website to retrieve and acquire the related images. Such an operation is quite complex and not favorable for improving the entering efficiency of the user, thereby resulting in poor user experience.

### SUMMARY

In view of this, the main objective of the disclosure is to provide an image retrieval method and system for a community website page, in order to reduce the complexity of image acquisition for a user in the page entering process and improve the entering efficiency.

To achieve the objective above, the technical scheme of the disclosure is implemented as follows.

The disclosure provides an image retrieval method for a community website page, comprising:

acquiring image retrieval keywords from the community website page and retrieving images in a corresponding search engine according to the acquired keywords; and

displaying the retrieved images via the community website page.

Preferably, retrieving the images in the corresponding search engine according to the acquired keyword comprises:

capturing, by means of the search engine, from an image resource website or an image repository images whose image indexes are matched with the keywords as said retrieved images.

Preferably, acquiring the image retrieval keywords from the community website page comprises:

extracting the keywords from a search engine entry of the community website page.

Preferably, acquiring the image retrieval keywords from the community website page comprises:

selecting, from input text entered on the community website page, feature keywords as said image retrieval keywords.

Preferably, the method further comprises:

selecting the feature keywords from the input text T, the set of the feature keywords being marked as a vector W, where W={w₁,w₂,w₃, . . . ,wₘ}, wᵢ represents a feature keyword i, 1≦i≦m, and m is a positive integer;

calculating the importance value of each feature keyword with respect to the input text T, the vector of the importance value corresponding to W being marked as F, where F={f₁,f₂,f₃, . . . ,fₘ}, fᵢ represents the importance value of wᵢ, 1≦i≦m, and m is a positive integer;

wherein the set of the images corresponding to image indexes captured by the search engine is marked as a vector P, where P={p_{q},p₂,p₃, . . . ,pₙ}, pⱼ represents an image j, 1≦j≦n and n is a positive integer; the vector of the words corresponding to the image pj is marked as Wⱼ, and the corresponding importance value is marked as Fⱼ, where Wⱼ={w′₁,w′₂,w′₃,w′_{q}}, w′ₖ represents an index word k of pᵢ, Fⱼ={f′₁,f′₂,f′₃, . . . ,f′_{q}}, f′ₖ represents the importance value of w′ₖ, 1≦k≦q, q is a positive integer; wherein the method further comprises calculating a recommendation value S(T, pⱼ)=F·Fⱼ of the image pⱼ and selecting an image with the largest S or multiple images in a descending order of S as the final retrieved images.

Preferably, after the image retrieval keywords are acquired from the community website page, the method further comprises normalizing the keywords;

and correspondingly, the keywords used in the retrieving step are those normalized ones.

Preferably, the normalization comprises:

searching for a preset normalization database according to the keywords acquired from the community website page; if the keywords are matched with normalization words in the database, taking the matched normalization words as the normalized keywords; and if the keywords are matched with non-normalization words in the database, taking the normalization words corresponding to the matched non-normalization words as the normalized keywords.

Preferably, the images are displayed via the community website page in a page pop-up way or a display area division way.

Preferably, the method further comprises: presetting a sorting rule and a display range for the images; and sorting the retrieved images according to the preset sorting rule and displaying them in the preset display range.

Preferably, the sorting rule is that the retrieved images are sorted in a descending order of the matching degrees between the keywords and the image indexes.

The disclosure also provides an image retrieval system for a community website page, comprising an image retrieval module and an image display module, wherein the image retrieval module is configured to acquire image retrieval keywords from the community website page and to retrieve images in a corresponding search engine according to the acquired keywords; and

the image display module is configured to display the retrieved images via the community website page.

Preferably, the image retrieval module is further configured to capture by means of the search engine from an image resource website or an image repository images whose image indexes are matched with the keywords as said retrieved images.

Preferably, the image retrieval module is further configured to extract the keywords from a search engine entry of the community website page.

Preferably, the image retrieval module is further configured to select from input text entered on the community website page feature keywords as said image retrieval keywords.

Preferably, the image retrieval module is further configured to:

select the feature keywords from the input text T, the set of the feature keywords being marked as a vector W, where W={w₁,w₂,w₃, . . . ,wₘ}, wᵢ represents a feature keyword i, 1≦i≦m, and m is a positive integer;

calculate the importance value of each feature keyword with respect to the input text T and the vector of the importance value corresponding to W being marked as F, where F={f₁,f₂,f₃, . . . ,fₘ}, fᵢ represents the importance value of wᵢ, 1≦i≦m, and m is a positive integer,

wherein the set of the images corresponding to image indexes captured by the search engine is marked as a vector P, where P={p₁,p₂,p₃, . . . ,pₙ}, pⱼ represents an image j, 1≦j≦n and n is a positive integer; the vector of the words corresponding to the image pj is marked as Wⱼ, and the corresponding importance value is marked as Fⱼ, where Wⱼ={w′₁,w′₂,w′₃, . . . ,w′_{q}}, w′ₖ represents an index word k of pᵢ, Fⱼ={f′₁,f′₂,f′₃, . . . ,f′_{q}}, f′ₖ represents the importance value of w′ₖ, 1≦k≦q, q is a positive integer; wherein the image retrieval module is further configured to calculate a recommendation value S(T, pⱼ)=F·Fⱼ of the image pⱼ and to select an image with the largest S or multiple images in a descending order of S as the final retrieved images.

Preferably, the image retrieval module is further configured to normalize the acquired keywords and to retrieve images in the corresponding search engine according to the normalized keywords.

Preferably, the normalization comprises:

searching for a preset normalization database according to the keywords acquired from the community website page; if the keywords are matched with normalization words in the database, taking the matched normalization words as the normalized keywords; and if the keywords are matched with non-normalization words in the database, taking the normalization words corresponding to the matched non-normalization words as the normalized keywords.

Preferably, the image display module is further configured to display the retrieved images via the community website page in a page pop-up way or a display area division way.

Preferably, the image display module is further configured to preset a sorting rule and a display range for the images, to sort the retrieved images according to the preset sorting rule and to display them in the preset display range.

Preferably, the sorting rule is that the retrieved images are sorted in a descending order of the matching degrees between the keywords and the image indexes.

Through the image retrieval method and system for the community website page provided by the disclosure, the image retrieval keywords are acquired from the community website page and the images are retrieved in the corresponding search engine according to the acquired keywords; and the retrieved images are displayed via the community website page. Through the disclosure, the retrieval operation for the acquired images is simplified and the complexity of image acquisition is reduced for the user in the page entering process, thereby improving the entering efficiency and enhancing the user experience.

### BRIEF DESCRIPTION OF THE DRAWINGS

FIG. 1 is a diagram I showing a micro blog community page in the prior art;

FIG. 2 is a diagram II showing a micro blog community page in the prior art;

FIG. 3 is a flowchart diagram of an image retrieval method for a community website page in an embodiment of the disclosure;

FIG. 4 is a flowchart diagram of an image retrieval method for a community website page in the first embodiment of the disclosure;

FIG. 5 is a diagram showing a micro blog community page in the first embodiment of the disclosure;

FIG. 6 is a diagram showing image retrieval in the first embodiment of the disclosure;

FIG. 7 is a flowchart of an image retrieval method for a community website page in the second embodiment of the disclosure; and

FIG. 8 is a diagram showing image retrieval in the second embodiment of the disclosure.

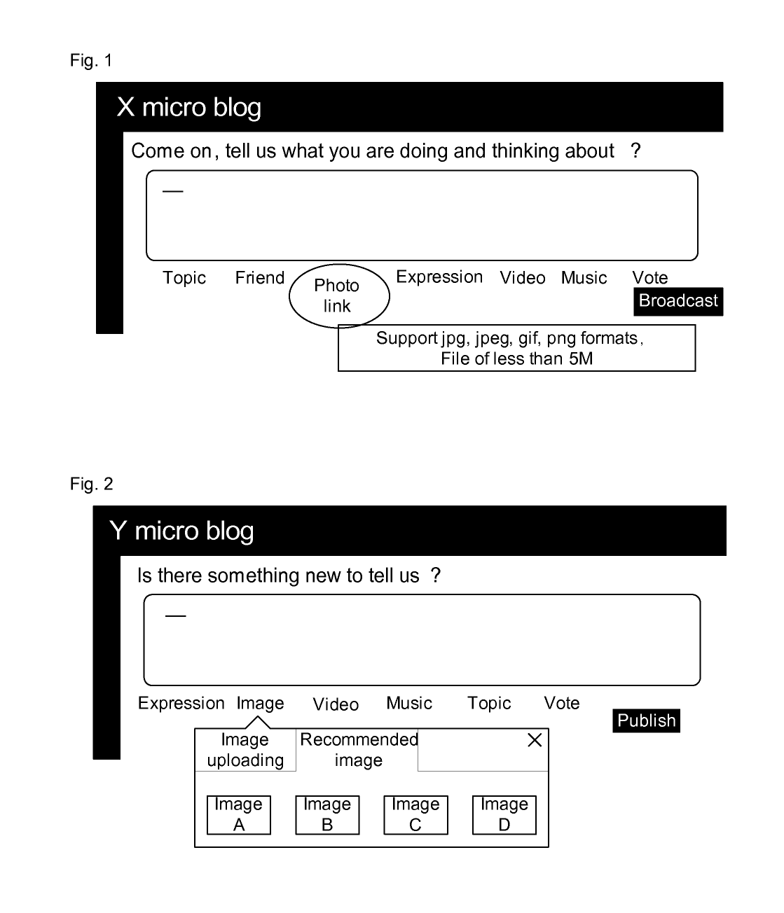

### DETAILED DESCRIPTION

The technical scheme of the disclosure is further explained below in detail by combining the drawings with specific embodiments.

To simplify the retrieval operation for the acquired images for a user in the page entering process, the disclosure aims to enable the community website page where user enters a text to execute image retrieval automatically, so as to save the operation of the user.

An embodiment of the disclosure provides an image retrieval method for a community website page, as shown in FIG. 3, mainly including:

Step 301: Image retrieval keywords are acquired from the community website page and images are retrieved in a corresponding search engine according to the acquired keywords.

A community website client can extract the keywords from a search engine entry of the community website page as the image retrieval keywords; the community website client can also select feature keywords from input text entered on the community website page as the image retrieval keywords. After acquiring the image retrieval keywords, the community website client captures by means of the search engine, from an image resource website or an image repository images whose image indexes are matched with the keywords as the retrieved images.

Preferably, after the image retrieval keywords are acquired from the community website page, the keywords can be normalized, such as synonym normalization and misspelling correction, so the keywords used in the image retrieval are those normalized ones. For example, the keyword “colourful cloud ( [symbol] )” for image retrieval acquired from the community website page is subjected to synonym normalization to obtain the keyword “cloud ( [symbol] )”; and the keyword “clout ( [symbol] )” for image retrieval acquired from the community website page is subjected to misspelling correction to obtain the keyword “cloud ( [symbol] )”.

The premise of normalization is to set up a normalization database in advance, in which the mapping relations between non-normalization words and normalization words are saved; and multiple non-normalization words can be mapped to the same normalization word, for example, both “colourful cloud ( [symbol] )” and “clout ( [symbol] )” are mapped to “cloud ( [symbol] )”. The so-called normalization words refer to words unified after normalization; and the so-called non-normalization words refer to various non-standard words corresponding to the normalization words.

The normalization specifically includes:

the normalization database is searched according to the keywords acquired from the community website page; if the keywords are matched with the normalization words in the database, the matched normalization words are taken as the normalized keywords; and if the keywords are matched with the non-normalization words in the database, the normalization words corresponding to the matched non-normalization words are taken as the normalized keywords.

That is to say, the normalized keywords all adopt the normalization words in the normalization database.

Step 302: The retrieved images are displayed via the community website page.

The retrieved images can be sorted and displayed in a descending order of the matching degrees between the keywords and the image indexes.

The images can be displayed in a page pop-up way of which the specific operation is: popping up an image display window on the community website page to import the retrieved images therein to display; and the images can also be displayed in a display area division way of which the specific operation is: dividing out a display area separately on the community website page to import the retrieved images therein to display. It should be noted that the embodiment of the disclosure is not only limited to the image display ways above, which can be further expanded according to the actual requirement.

In addition, the image retrieval method in the embodiment of the disclosure further includes: a sorting rule and a display range are preset for the images; and the retrieved images are sorted according to the sorting rule and displayed in the display range. The sorting rule is, for example, the retrieved images are sorted in a descending order of the matching degrees between the keywords and the image indexes. The display range is, for example, at most M images are displayed in a display window or a display area page by page, with each page displaying N images and supporting page turning. M and N are set according to the actual requirement.

Correspondingly, the images are displayed specifically as follows: the matching degrees between the image indexes of the retrieved images and the keywords are calculated; and the images are sorted according to the calculated matching degrees and the preset sorting rule and displayed in the preset display range.

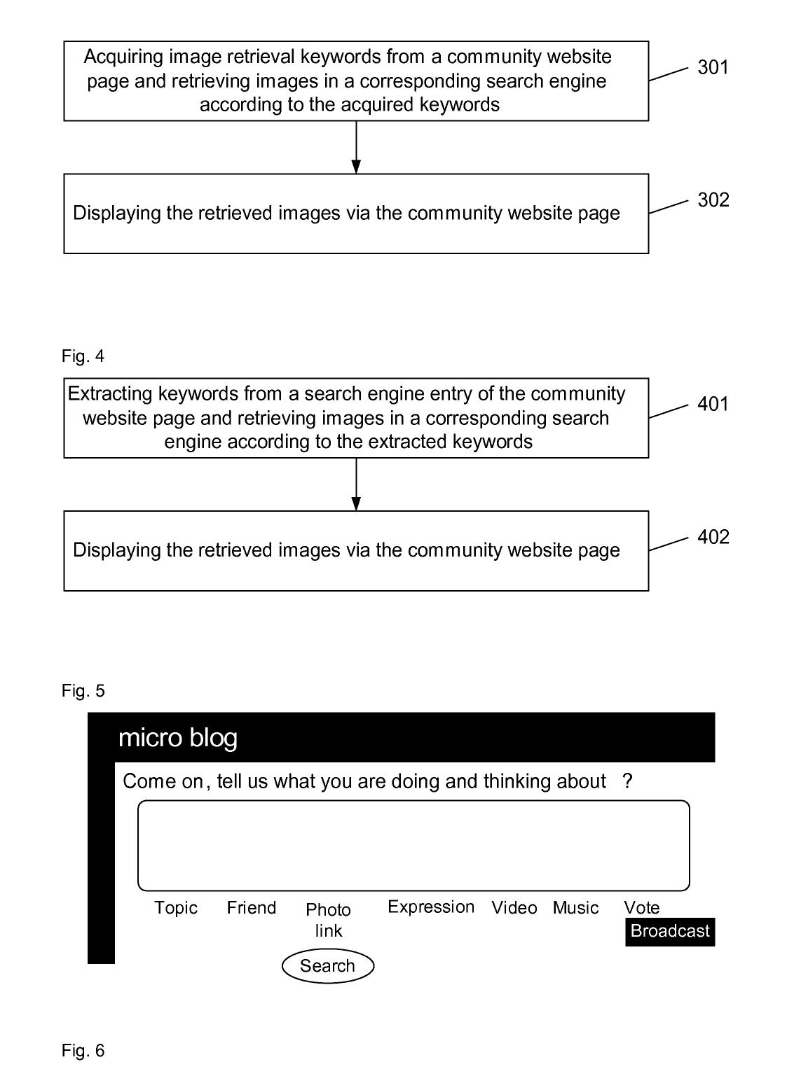

For example, the keywords are extracted from the search engine entry of the community website page, the image retrieval method of the disclosure is further described below in detail. The first embodiment of the disclosure provides an image retrieval method for a community website page, as shown in FIG. 4, mainly including:

Step 401: Keywords are extracted from a search engine entry of the community website page and images are retrieved in a corresponding search engine according to the extracted keywords.

With an image search function provided on the interface of the community website page, a user can directly submit image query keywords through a search engine entry on the community website page; and a community website client captures images whose image indexes are matched with the keywords from an image resource website or an image repository by a search engine to take them as the retrieved images. With a micro blog community as an example, as shown in FIG. 5, with the search engine entry provided on the interface of the micro blog community, the user clicks “search” button to trigger the search engine entry to submit the image query keywords through the entry; and the micro blog community captures the images whose image indexes matched with the keywords from the image resource website or the image repository by the associated search engine to take them as the retrieved images. The search engine has an index function, in which each retrieved image is provided with an image index; and the words in the image indexes are from the text around the images on the website page during image acquisition. For example, if the user submits the keywords “sun ( [symbol] [symbol] )” and “moon ( [symbol] )”, a micro blog community client captures the images of which the image indexes contain “sun ( [symbol] )” and/or “moon ( [symbol] )” from the image resource website or the image repository by the associated search engine to take them as the retrieved images.

Step 402: The retrieved images are displayed via the community website page.

Still with a micro blog community as an example, a preferred image retrieval process is as shown in FIG. 6, specifically, a user submits image query keywords through a micro blog search engine entry and the micro blog performs query string processing on the keywords, i.e., normalization, including: synonym normalization, misspelling correction and the like; then, the images of which the image indexes are matched with the keywords are captured from an image resource website or an image repository by the associated search engine according to the normalized keywords, specifically, the search engine captures the images from the image resource website or the image repository through a web crawler according to the keywords and the index module of the search engine sets up an image index for each captured image, wherein the words in the image indexes are from the text around the images on the website page during image acquisition; and a micro blog client processes the images in the indexes by the keywords in combination with the image indexes, such as filtering and sorting, and sorts the retrieved images in a descending order of the matching degrees between the keywords and the image indexes (such as the matching numbers of the image indexes and the keywords) and displays them through a micro blog interface. The crawler, a program capable of acquiring webpage contents automatically, is an important component of the search engine.

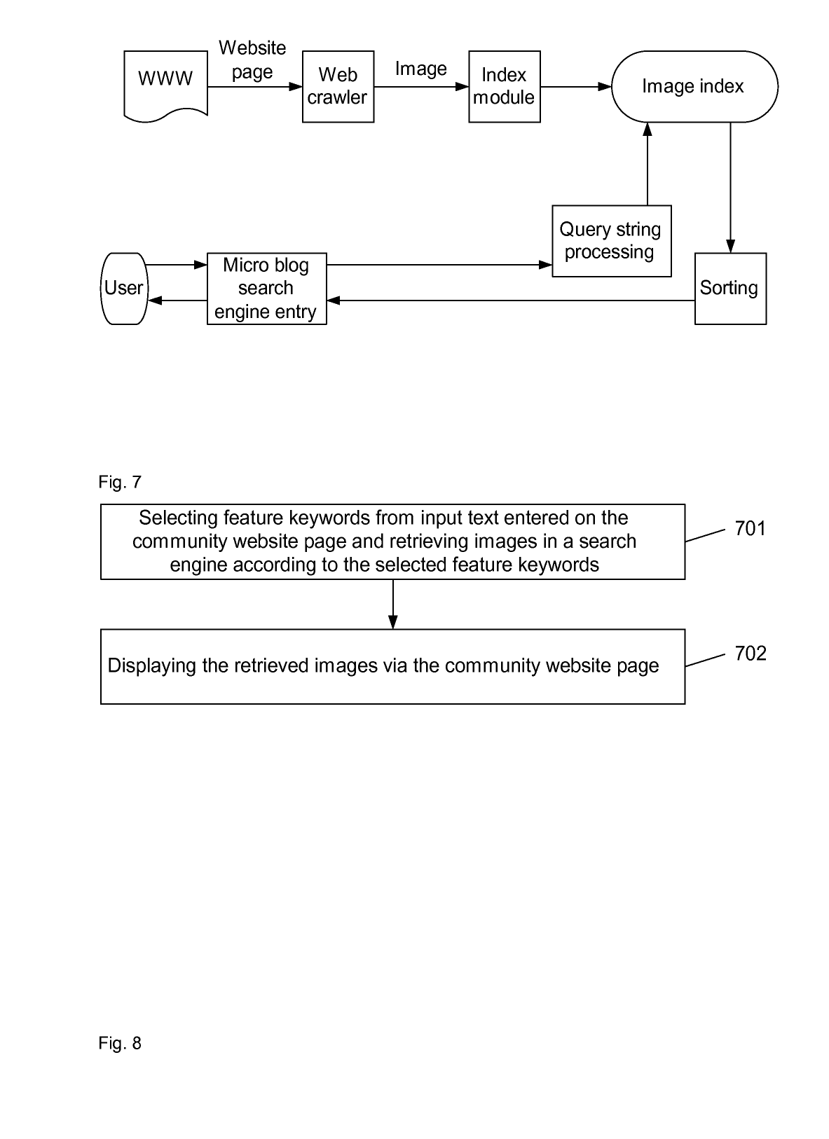

In the first embodiment, the user is required to trigger the search proactively and enter the query keywords to acquire a required image. The second embodiment of the disclosure provides an image retrieval method for a community website page, by which related images are retrieved and recommended automatically according to the contents entered by the user, as shown in FIG. 7, mainly including the following steps:

Step 701: Feature keywords are selected from the text entered on the community 30 website page and images are retrieved in a search engine according to the selected feature keywords.

A community website client selects the feature keywords from the text entered by a user in real time and sends the selected feature keywords to the search engine; and the search engine captures the images of which the image indexes are matched with the feature keywords from an image resource website or an image repository to take them as the retrieved images.

A preferred retrieval way can further include:

the community website client selects the feature keywords from the input text T and the set of the feature keywords is marked as a vector W, where W={w₁,w₂,w₃, . . . ,wₘ}, wᵢ represents a feature keyword i, 1≦i≦m, and m is a positive integer;

the importance value of each feature keyword with respect to the input text T is calculated and the vector of the importance value corresponding to W is marked as F, where F={f₁,f₂,f₃, . . . ,fₘ}, fᵢ represents the importance value of wᵢ, 1≦i≦m, and m is a positive integer;

the set of the images corresponding to image indexes captured by the search engine is marked as a vector P, where P={p₁,p₂,p₃, . . . ,pₙ}, pⱼ represents an image j, 1≦j≦n and n is a positive integer; the vector of the words corresponding to the image pj is marked as W_{J}, and the corresponding importance value is marked as Fⱼ, where Wⱼ={w′₁,w′₂,w′₃, . . . ,w′_{q}}, w′ₖ represents an index word k of pᵢ, fⱼ={f′₁,f′₂,f′₃, . . . ,f′_{q}}, f′ₖ, represents the importance value of w′ₖ, 1≦k≦q, q is a positive integer; and a recommendation value S(T, pⱼ)=F·Fⱼ of the image pⱼ is calculated to select an image with the largest S or multiple images in a descending order of S (the number is set according to the requirement of the actual displaying) as the final retrieved images.

Step 702: The retrieved images are displayed via the community website page.

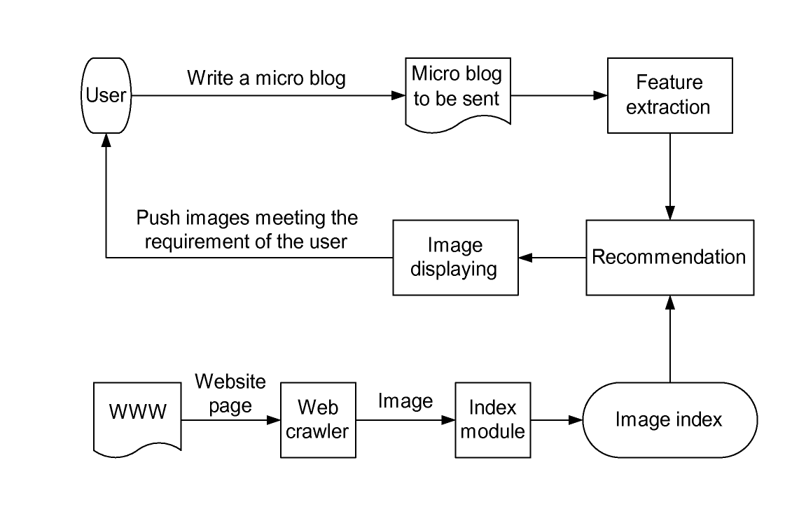

Still with a micro blog community as an example, a preferred image retrieval process is as shown in FIG. 8, specifically, a micro blog client selects the feature keywords from the text entered by the user in real time and the set of the feature keywords is marked as a vector W, where W={w₁,w₂,w₃, . . . ,wₘ}, wᵢ represents a feature keyword i, 1≦i≦m, and m is a positive integer; the importance value of each feature keyword with respect to the input text T is calculated and the vector of the importance value with respect to W is marked as F, where F={f₁,f₂,f₃, . . . ,fₘ}, fᵢ represents the importance value of wᵢ, 1≦i≦m, and m is a positive integer; the selected feature keywords are sent to the search engine which captures images from an image resource website or an image repository by a web crawler according to the feature keywords, and the index module of the search engine sets up an image index for each captured image, wherein the words in the image indexes are from the text around the images on the website page during image acquisition and the image retrieval module has an image recommendation function; the set of the images corresponding to image indexes captured by the search engine is marked as a vector P, where P={p₁,p₂,p₃, . . . ,pₙ}, pⱼ represents an image j, 1≦j≦n and n is a positive integer; the vector of words corresponding to the image pj is marked as Wⱼ, and the corresponding importance value is marked as Fⱼ, where Wⱼ={w′₁,w′₂,w′₃, . . . ,w′_{q}}, w′ₖ represents an index word k of pᵢ, Fⱼ={f′₁,f′₂,f′₃, . . . ,f′_{q}}, f′ₖ represents the importance value of w′ₖ, 1≦k≦q, q is a positive integer; the image retrieval module calculates the recommendation value S(T,pⱼ)=F·Fof the image pⱼ to select the image with the largest S or take multiple images as the final retrieved images in a descending order of S, that is, an optimization objective function of the image retrieval module is as follows:

arg maxₚΣS(T,pᵢ), where pᵢ∈P

The meaning of the function is to select the one with the largest S in P as the final result.

Corresponding to the image retrieval method for the community website page, the embodiment of the disclosure further provides an image retrieval system for a community website page, mainly including: an image retrieval module and an image display module. The image retrieval module is configured to acquire image retrieval keywords from the community website page and to retrieve images in a corresponding search engine according to the acquired keywords; and the image display module is configured to display the retrieved images via the community website page.

Preferably, the image retrieval module can be configured to capture by means of the search engine from an image resource website or an image repository images whose image indexes are matched with the keywords as said retrieved images.

Preferably, the image retrieval module can be further configured to extract the keywords from a search engine entry of the community website page or to select from an input text entered on the community website page feature keywords as the image retrieval keywords.

Preferably, the image retrieval module can be further configured to select the 30 feature keywords from the input text T, the set of the feature keywords being marked as a vector W, where W={w₁,w₂,w₃, . . . ,wₘ}, wᵢ represents a feature keyword i, 1≦i≦m, and m is a positive integer;

calculate the importance value of each feature keyword with respect to the input text T and the vector of the importance value corresponding to W being marked as F, where F={f₁,f₂,f₃, . . . ,fₘ}, fᵢ represents the importance value of wᵢ, and m is a positive integer,

wherein the set of the images corresponding to image indexes captured by the search engine is marked as a vector P, where P={p₁,p₂,p₃, . . . ,pₙ}, pⱼ represents an image j, 1≦j≦n and n is a positive integer; the vector of the words corresponding to the image pj is marked as Wⱼ, and the corresponding importance value is marked as Fⱼ, where Wⱼ={w′₁,w′₂,w′₃, . . . ,w′_{q}}, w′ₖ represents an index word k of pᵢ, Fⱼ={f′₁,f′₂,f′₃, . . . ,f′_{q}}, f′ₖ represents the importance value of w′ₖ, 1≦k≦1, q is a positive integer; wherein the image retrieval module is further configured to calculate a recommendation value S(T, pⱼ)=F·Fⱼ of the image pⱼ and to select an image with the largest S or multiple images in a descending order of S as the final retrieved images.

16. The image retrieval system for the community website page according to claim 11 or 12, wherein the image retrieval module is further configured to normalize the acquired keywords and to retrieve images in the corresponding search engine according to the normalized keywords.

Preferably, the image retrieval module can be further configured to normalize the acquired keywords and to retrieve the images in the corresponding search engine according to the normalized keywords.

The normalization includes:

a preset normalization database is searched according to the keywords acquired from the community website page; if the keywords are matched with normalization words in the database, the matched normalization words are taken as the normalized keywords; and if the keywords are matched with non-normalization words in the database, the normalization words corresponding to the matched non-normalization words are taken as the normalized keywords.

Preferably, the image display module can be further configured to display the retrieved images via the community website page in a page pop-up way or a display area division way.

Preferably, the image display module can be further configured to preset a sorting rule and a display range for the images to sort the retrieved images according to the preset sorting rule and to display them in the preset display range.

Preferably, the sorting rule is that the retrieved images are sorted in a descending order of the matching degrees between the keywords and the image indexes.

It should be noted that the scheme of the disclosure is not only suitable for a micro blog community website but also suitable for community websites or websites of other types in any form on a page of which a user can enter a text. Through the disclosure, the retrieval for the acquired images is simplified and the complexity of image acquisition is reduced for the user in the page entering process, thereby improving the entering efficiency and enhancing the user experience.

What said above are only the preferred embodiments of the disclosure, and not intended to limit the scope of protection of the disclosure.

1. An image retrieval method for a community website page, comprising:
acquiring image retrieval keywords from the community website page and retrieving images in a corresponding search engine according to the acquired keywords; and
displaying the retrieved images via the community website page.

2. The image retrieval method for the community website page according to claim 1, wherein acquiring the image retrieval keywords from the community website page comprises:
extracting the keywords from a search engine entry of the community website page or selecting, from input text entered on the community website page, feature keywords as said image retrieval keywords.

3. The image retrieval method for the community website page according to claim 1, wherein acquiring the image retrieval keywords from the community website page comprises selecting, from input text entered on the community website page, feature keywords as said image retrieval keywords,
wherein the method further comprises:
selecting the feature keywords from the input text T, the set of the feature keywords being marked as a vector W, where W={w₁,w₂,w₃, . . . ,wₘ}, wᵢ represents a feature keyword i, 1≦i≦m, and m is a positive integer;
calculating the importance value of each feature keyword with respect to the input text T, the vector of the importance value corresponding to W being marked as F, where F={f₁,f₂,f₃, . . . ,fₘ}, fᵢ represents the importance value of wᵢ, 1≦i≦m, and m is a positive integer;
wherein the set of the images corresponding to image indexes captured by the search engine is marked as a vector P, where P={p₁,p₂,p₃, . . . ,pₙ}, pᵢ represents an image i, 1≦j≦n and n is a positive integer; the vector of the words corresponding to the image pi is marked as Wᵢ, and the corresponding importance value is marked as Fᵢ, where Wᵢ={w′₁,w′₂,w′₃, . . . w′_{q}}, w′ₖ represents an index word k of pᵢ, Fᵢ={f′₁,f′₂,f′₃, . . . ,f′_{q}}, f′ₖ represents the importance value of w′ₖ, 1≦k≦q, q is a positive integer; wherein the method further comprises calculating a recommendation value S (T, pᵢ)=F·Fᵢ of the image pᵢ and selecting an image with the largest S or multiple images in a descending order of S as the final retrieved images.

4. The image retrieval method for the community website page according to claim 1, wherein acquiring the image retrieval keywords from the community website page comprises selecting, from input text entered on the community website page, feature keywords as said image retrieval keywords,
wherein the method further comprises:
selecting the feature keywords from the input text T, the set of the feature keywords being marked as a vector W, where W={w₁,w₂,w₃. . . . , wₘ}, wᵢ represents a feature keyword i, 1≦i≦m, and m is a positive integer;
calculating the importance value of each feature keyword with respect to the input text T, the vector of the importance value corresponding to W being marked as F, where F={f₁,f₂,f₃, . . . ,fₘ}, fᵢ represents the importance value of wᵢ, 1≦i≦m, and m is a positive integer;
wherein the set of the images corresponding to image indexes captured by the search engine is marked as a vector P, where P={p₁,p₂,p₃, . . . ,pₙ}, pᵢ represents an image i, 1≦j≦n and n is a positive integer; the vector of the words corresponding to the image pj is marked as Wᵢand the corresponding importance value is marked as Fᵢ, where Wᵢ={w′₁,w′₂,w′₃, . . . ,w′_{q}}, w′ₖ represents an index word k of pᵢ, fᵢ={f′₁,f′₂,f′₃, . . . , f′_{q}}, f′ₖ represents the importance value of w′ₖ, 1≦k≦q, q is a positive integer; wherein the method further comprises calculating recommendation value S(T, pᵢ)=F·Fᵢ of the image pᵢ and selecting an image with the largest S or multiple images in a descending order of S as the final retrieved images.

5. The image retrieval method for the community website page according to claim 1, wherein after the image retrieval keywords are acquired from the community website page, the method further comprises normalizing the keywords;
and correspondingly, the keywords used in the retrieving step are those normalized ones,
wherein the normalization comprises:
searching for a preset normalization database according to the keywords acquired from the community website page; if the keywords are matched with normalization words in the database, taking the matched normalization words as the normalized keywords; and if the keywords are matched with non-normalization words in the database, taking the normalization words corresponding to the matched non-normalization words as the normalized keywords.

6. The image retrieval method for the community website page according to claim 3, wherein after the image retrieval keywords are acquired from the community website page, the method further comprises normalizing the keywords;
and correspondingly, the keywords used in the retrieving step are those normalized ones,
wherein the normalization comprises:
searching for a preset normalization database according to the keywords acquired from the community website page; if the keywords are matched with normalization words in the database, taking the matched normalization words as the normalized keywords; and if the keywords are matched with non-normalization words in the database, taking the normalization words corresponding to the matched non-normalization words as the normalized keywords.

7. The image retrieval method for the community website page according to claim 1, further comprising: presetting a sorting rule and a display range for the images; and sorting the retrieved images according to the preset sorting rule and displaying them in the preset display range.

8. The image retrieval method for the community website page according to claim 3, further comprising: presetting a sorting rule and a display range for the images; and sorting the retrieved images according to the preset sorting rule and displaying them in the preset display range.

9. The image retrieval method for the community website page according to claim 1, wherein retrieving the images in the corresponding search engine according to the acquired keyword comprises:
capturing, by means of the search engine, from an image resource website or an image repository images whose image indexes are matched with the keywords as said retrieved images.

10. The image retrieval method for the community website page according to claim 3, wherein retrieving the images in the corresponding search engine according to the acquired keyword comprises:
capturing, by means of the search engine, from an image resource website or an image repository images whose image indexes are matched with the keywords as said retrieved images.

11. An image retrieval system for a community website page, comprising an image retrieval module and an image display module, wherein
the image retrieval module is configured to acquire image retrieval keywords from the community website page and to retrieve images in a corresponding search engine according to the acquired keywords; and
the image display module is configured to display the retrieved images via the community website page.

12. The image retrieval system for the community website page according to claim 11, wherein the image retrieval module is further configured to extract the keywords from a search engine entry of the community website page or to select from input text entered on the community website page feature keywords as said image retrieval keywords.

13. The image retrieval system for the community website page according to claim 11, wherein the image retrieval module is further configured to select from input text entered on the community website page feature keywords as said image retrieval keywords,
wherein the image retrieval module is further configured to:
select the feature keywords from the input text T, the set of the feature keywords being marked as a vector W where W={w₁,w₂,w₃, . . . ,wₘ}, wᵢ represents a feature keyword i, 1≦i≦m, and m is a positive integer;
calculate the importance value of each feature keyword with respect to the input text T and the vector of the importance value corresponding to W being marked as F, where F={f₁,f₂, f₃, . . . ,fₘ}, fᵢ represents the importance value of wᵢ, 1≦i≦m, and m is a positive integer,
wherein the set of the images corresponding to image indexes captured by the search engine is marked as a vector P, where P={p₁,p₂,p₃, . . . ,pₙ}, pᵢ represents an image i, 1≦i≦n and n is a positive integer; the vector of the words corresponding to the image pi is marked as wᵢ, and the corresponding importance value is marked as Fᵢ, where Wᵢ={w′₁,w′₂,w′₃, . . . ,w′_{q}}, w′ₖ represents an index word k of pᵢ, fᵢ={f′₁,f′₂,f′₃, . . . ,f′_{q}}, f′ₖ represents the importance value of w′ₖ, 1≦k≦q, q is a positive integer; wherein the image retrieval module is further configured to calculate a recommendation value S(T, pᵢ)=F·Fᵢ of the image pᵢ and to select an image with the largest S or multiple images in a descending order of S as the final retrieved images.

14. The image retrieval system for the community website page according to claim 11, wherein the image retrieval module is further configured to select from input text entered on the community website page feature keywords as said image retrieval keywords,
wherein the image retrieval module is further configured to:
select the feature keywords from the input text T, the set of the feature keywords being marked as a vector W where W={w₁,w₂,w₃, . . . ,wₘ}, wᵢ represents a feature keyword i, 1≦i≦m, and m is a positive integer;
calculate the importance value of each feature keyword with respect to the input text T and the vector of the importance value corresponding to W being marked as F, where F={f₁,f₂,f₃, . . . ,fₘ}, fᵢ represents the importance value of wᵢ, 1≦i≦m, and m is a positive integer,
wherein the set of the images corresponding to image indexes captured by the search engine is marked as a vector P, where P={p₁,p₂p₃, . . . ,pₙ}, pᵢ represents an image i, 1≦i≦n and n is a positive integer; the vector of the words corresponding to the image is pi is marked as Wᵢ, and the corresponding importance value is marked as Fᵢ, where Wᵢ={w′₁,w′₂,w′₃, . . . , w′_{q}}, w′ₖ represents an index word k of pᵢ, Fᵢ={f′₁f′₂,f′₃, . . . ,f′_{q}}, f′ₖ represents the importance value of w′ₖ,1≦k≦q, q is a positive integer; wherein the image retrieval module is further configured to calculate a recommendation value S(T, pᵢ)=F·Fᵢ of the image pᵢ and to select an image with the largest S or multiple images in a descending order of S as the final retrieved images.

15. The image retrieval system for the community website page according to claim 11, wherein the image retrieval module is further configured to normalize the acquired keywords and to retrieve images in the corresponding search engine according to the normalized keywords,
wherein the normalization comprises:
searching for a preset normalization database according to the keywords acquired from the community website page; if the keywords are matched with normalization words in the database, taking the matched normalization words as the normalized keywords; and if the keywords are matched with non-normalization words in the database, taking the normalization words corresponding to the matched non-normalization words as the normalized keywords.

16. The image retrieval system for the community website page according to claim 13, wherein the image retrieval module is further configured to normalize the acquired keywords and to retrieve images in the corresponding search engine according to the normalized keywords,
wherein the normalization comprises:
searching for a preset normalization database according to the keywords acquired from the community website page; if the keywords are matched with normalization words in the database, taking the matched normalization words as the normalized keywords; and if the keywords are matched with non-normalization words in the database, taking the normalization words corresponding to the matched non-normalization words as the normalized keywords.

17. The image retrieval system for the community website page according to claim 11, the image display module is further configured to preset a sorting rule and a display range for the images, to sort the retrieved images according to the preset sorting rule and to display them in the preset display range.

18. The image retrieval system for the community website page according to claim 13, the image display module is further configured to preset a sorting rule and a display range for the images, to sort the retrieved images according to the preset sorting rule and to display them in the preset display range.

19. The image retrieval system for the community website page according to claim 11, wherein the image retrieval module is further configured to capture by means of the search engine from an image resource website or an image repository images whose image indexes are matched with the keywords as said retrieved images.

20. The image retrieval system for the community website page according to claim 13, wherein the image retrieval module is further configured to capture by means of the search engine from an image resource website or an image repository images whose image indexes are matched with the keywords as said retrieved images.

21. The image retrieval method for the community website page according to claim 4, wherein after the image retrieval keywords are acquired from the community website page, the method further comprises normalizing the keywords;
and correspondingly, the keywords used in the retrieving step are those normalized ones,
wherein the normalization comprises:
searching for a preset normalization database according to the keywords acquired from the community website page; if the keywords are matched with normalization words in the database, taking the matched normalization words as the normalized keywords; and if the keywords are matched with non-normalization words in the database, taking the normalization words corresponding to the matched non-normalization words as the normalized keywords.

22. The image retrieval method for the community website page according to claim 4, further comprising: presetting a sorting rule and a display range for the images; and sorting the retrieved images according to the preset sorting rule and displaying them in the preset display range.

23. The image retrieval method for the community website page according to claim 4, wherein retrieving the images in the corresponding search engine according to the acquired keyword comprises:
capturing, by means of the search engine, from an image resource website or an image repository images whose image indexes are matched with the keywords as said retrieved images.

24. The image retrieval system for the community website page according to claim 14, wherein the image retrieval module is further configured to normalize the acquired keywords and to retrieve images in the corresponding search engine according to the normalized keywords,
wherein the normalization comprises:
searching for a preset normalization database according to the keywords acquired from the community website page; if the keywords are matched with normalization words in the database, taking the matched normalization words as the normalized keywords; and if the keywords are matched with non-normalization words in the database, taking the normalization words corresponding to the matched non-normalization words as the normalized keywords.

25. The image retrieval system for the community website page according to claim 14, the image display module is further configured to preset a sorting rule and a display range for the images, to sort the retrieved images according to the preset sorting rule and to display them in the preset display range.

26. The image retrieval system for the community website page according to claim 14, wherein the image retrieval module is further configured to capture by means of the search engine from an image resource website or an image repository images whose image indexes are matched with the keywords as said retrieved images.
